(19) United States
(12) Patent Application Publication
(10) Pub. No.: US 2004/0256008 A1
(43) Pub. Date: Dec. 23, 2004

(54) Build-in pneumatic reducing valve for a gas-operated gun

(76) Inventor: Hai-Lung Huang, Tainan (TW)

Correspondence Address: Troxell Law Office PLLC, Suite 1404, 5205 Leesburg Pike, Falls Church, VA, 22041, US

(21) Appl. No.: 10/462,623

(22) Filed: Jun. 17, 2003

(51) Int. Cl. G05D 16/10

(52) U.S. Cl. 137/505.25

(57) ABSTRACT

A build-in pneumatic reducing valve for a gas-operated gun includes a valve body, a cartridge connector and a valve disk. The valve body has a valve seat and a cartridge connector seat that communicate with each other. The cartridge connector is mounted in the cartridge connector seat to engage a gas cartridge. The valve disk is slidably mounted in the valve seat to selectively form a restricted gap in the valve seat and has an enlarged valve port, a longitudinal passage and radial holes that communicate with one another. Also, the radial holes communicate with the restricted gap. Therefore, the compressed gas in the gas cartridge will enter the reducing valve such that the diminished pressures of the compressed gas will make operation of the gas-operated gun safe.

### BACKGROUND OF THE INVENTION

1. Field of the Invention

The present invention relates to a pneumatic reducing valve for gas-operated guns, and more particularly to a build-in pneumatic reducing valve for a gas-operated gun having a compressed gas cartridge, which will regulate compressed gas pressure discharged from the gas cartridge.

2. Description of Related Art

Compressed gas-operated guns are popular in head-to-head war games and are available in various types of rifles and pistols. A compressed gas-operated gun typically has a gas cartridge that provides compressed gas to propel plastic balls. The gas cartridge contains a high-pressure compressed gas to propel the balls from the gun. However, using the high-pressure compressed gas directly as a propellant for the balls is potentially hazardous, especially in an exciting head-to-head war game. The high-pressure compressed gas will propel the balls as such a high speed that balls shot from the gun can easily injure a person.

Accordingly, the pressure of the compressed gas in the gas cartridge must be reduced to a safe level and still provide adequate propellant force for the gas-operated guns to effectively operate in recreational activities. A built-in, compatible pneumatic reducing valve for the gas-operated guns is required to achieve the foresaid purposes.

To overcome the shortcomings, the present invention provides a build-in pneumatic reducing valve for gas-operated guns to mitigate or obviate the aforementioned problems.

### SUMMARY OF THE INVENTION

The main objective of the invention is to provide a built-in pneumatic reducing valve for a gas-operated gun that will reduce and regulate discharging compressed gas pressure from a gas cartridge in the gun. Furthermore, the pneumatic reducing valve is compatible with various types of gas-operated guns, such as rifles, pistols and other gas-operated guns.

Other objectives, advantages and novel features of the invention will become more apparent from the following detailed description when taken in conjunction with the accompanying drawings.

### BRIEF DESCRIPTION OF THE DRAWINGS

FIG. 1 is an operational, cross sectional side plan view of a pistol with a build-in pneumatic reducing valve in accordance with the present invention;

FIG. 2 is an enlarged, cross sectional side plan view of a clip for the pistol in FIG. 1;

FIG. 3 is an enlarged cross sectional side plan view of the reducing valve in FIG. 1; and

FIG. 4 is an operational side plan view in partial section of a portion of a gas-operated rifle with a built-in pneumatic reducing valve in FIG. 1.

### DETAILED DESCRIPTION OF PREFERRED EMBODIMENT

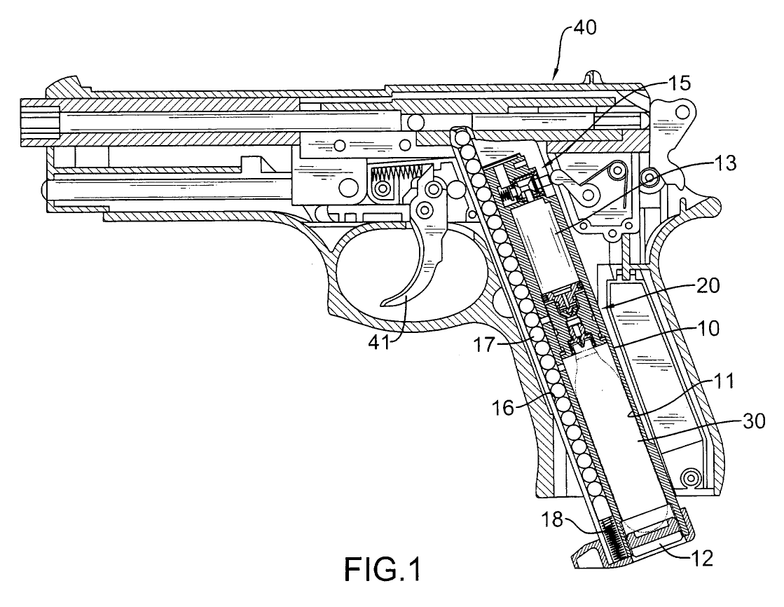

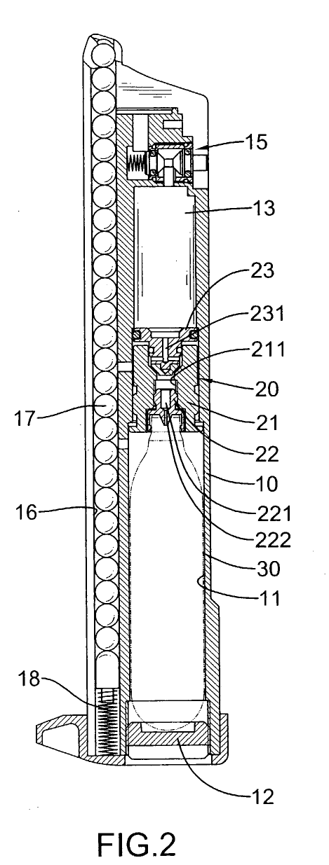

With reference to FIGS. 1 and 2, a pneumatic reducing valve (20) in accordance with the present invention is mounted in a removable cartridge device (not numbered) in a gas-operated gun such as a pistol (40). The pistol (40) has a trigger (41) and a cavity (not numbered) to hold the removable cartridge device. The removable cartridge device comprises a clip (10), a plug (12), an actuating valve (15) and a clip spring (18). The clip (10) has a proximal end (not numbered), a distal end (not numbered), a cartridge cavity (11) and an ammunition slot (16). The cartridge cavity (11) is defined through the distal end of the clip (10) toward the proximal end and has a bottom opening (not numbered). The actuating valve (15) is mounted in the cartridge cavity (11) adjacent to the proximal end of the clip (10) to discharge the compressed gas from the clip (10) when the trigger (41) is squeezed. Since operation of the actuating valve (15) and the trigger (41) is conventional and are not claimed as part of the present invention, a detailed description is not provided.

The reducing valve (20) is mounted in and divides the cartridge cavity (11) into a regulating chamber (13) and a cartridge chamber (not numbered). The regulating chamber (13) is formed between the actuating valve (15) and the reducing valve (20). The ammunition slot (16) is defined through the proximal end of the clip (10) to hold plastic balls (17) in sequence. The clip spring (18) is mounted in the ammunition slot (16) at the distal end of the clip (10) to push the plastic balls (17) toward the proximal end of the clip (10).

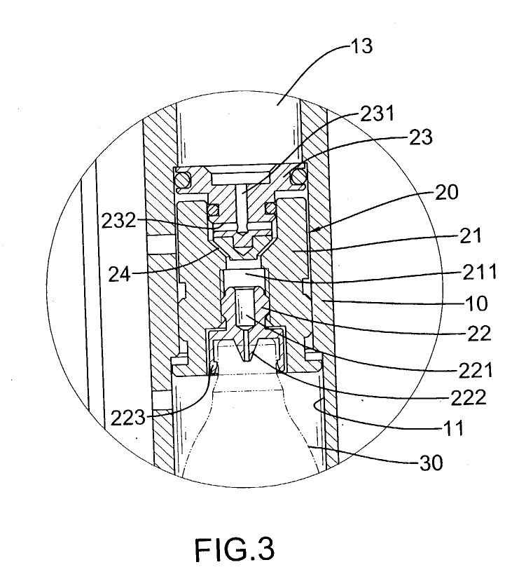

With further reference to FIG. 3, the pneumatic reducing valve (20) comprises a valve body (21), a cartridge connector (22) and a valve disk (23). The valve body (21) has a top (not numbered), a bottom (not numbered), a valve seat (not numbered), and a cartridge connector seat (211). The valve seat is defined through the top of the valve body (21). The cartridge connector seat (211) is defined through the bottom of the valve body (21) and communicates with the valve seat.

The cartridge connector (22) is mounted in the cartridge connector seat (211) and has a top (not numbered), a bottom (not numbered), an gas passage (221), a piercing needle (222) and a cartridge cap (223). The gas passage (221) is defined longitudinally through the top of the cartridge connector (22) and communicates with the cartridge connector seat (211). The piercing needle (222) is tapered at the bottom of the cartridge connector (22) and has an aperture (not numbered) that communicates with the gas passage (221). The cartridge cap (223) is formed on the bottom of the cartridge connector (22) around the piercing needle (222) to hold a gas cartridge (30) that contains compressed gas. When the gas cartridge (30) is attached to and is held by the cartridge cap (223), the piercing needle (222) punches a hole (not shown) in the gas cartridge (30) to allow the compressed gas to enter the cartridge connector seat (211) via the aperture in the piercing needle (222).

The valve disk (23) is slidably mounted in the valve seat in the valve body (21) to selectively form a restricted gap (24) in the valve seat and has O-rings (not numbered), a top disk (not numbered) and a bottom cylinder (not numbered) that are connected together. The top disk is slidably mounted in the regulating chamber (13) and has a top (not numbered), a first annular groove (not numbered) and an enlarged valve port (not numbered) defined through the top of the top disk. The first annular groove is defined around the top disk, and one O-ring is mounted in the first annular groove to prevent the compressed gas in the regulating chamber (13) from leaking out of the regulating chamber (13). The bottom cylinder is slidably mounted in the valve seat in the valve body (21) and has a longitudinal passage (231), at least one radial hole (232), a second annular groove (not numbered), a truncated conical bottom (not numbered) and a flat bottom end (not numbered). The flat bottom end of the bottom cylinder has a much smaller area than the top of the top disk. The second annular groove is defined around the bottom cylinder, and an O-ring is mounted in the second annular groove. The restricted gap (24) is formed between the truncated conical bottom of the bottom cylinder and the valve seat in the valve body (21). The radial holes (232) are defined in the bottom cylinder and communicate with the restricted gap (24). The longitudinal passage (231) is defined axially in the bottom cylinder and communicates with the radial holes (232) and the enlarged valve port in the top disk.

Therefore, the compressed gas in the cartridge connector seat (211) will enter the regulating chamber (13) through the restricted gap (24), the radial holes (232), the longitudinal passage (231) and the enlarged valve port of the top disk.

The principles of Boyle's Law cause the valve disk (23) to move into the valve seat and close the restricted gap (24). When the pressure of the gas in the regulating chamber (13) is much less than the pressure of the gas in the cartridge connector seat (211), the compressed air will flow through the restricted gap (24) and enter into the regulating chamber (13) where the cross sections of the restricted gap (24) and enter into the regulating chamber (13) are changed. The pressure of the gas in the regulating chamber (13) will be pressurized until the restricted gap (24) is closed. When gas is released from the regulating chamber (13) to shoot a plastic ball (17), the valve disk (23) slides toward the regulating chamber (13) and opens the restricted gap (24) allowing gas to flow into the regulating chamber (13) and pressure to build up until the valve disk (23) moves into the valve seat and closes the restricted gap (24) again. Consequently, a plastic ball (17) is shot from the gun at a reduced speed to prevent somebody from being injured by the plastic ball (17), especially in an exciting head-to-head war game.

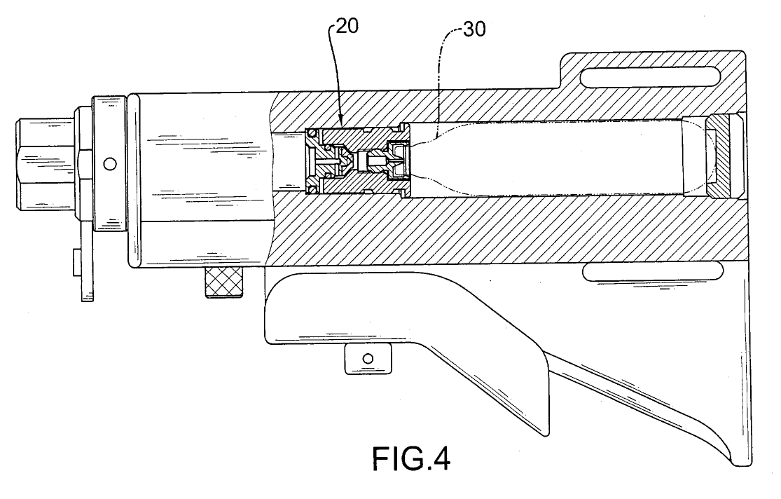

With reference to FIG. 4, a reducing valve (20) having the same features previously described can be mounted in a gas-operated rifle that uses a gas cartridge (30). Since the operation of the reducing valve (20) has been described, a detailed description is not provided.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A build-in pneumatic reducing valve for a gas-operated gun and the build-in pneumatic reducing valve comprising:
a valve body with a top and a bottom having a valve seat defined through the top and a cartridge connector seat defined through the bottom of the valve body and communicating with the valve seat;
a cartridge connector with a top and a bottom mounted in the cartridge connector seat and having
a gas passage defined through the top of the cartridge connector and communicating with the cartridge connector seat;
a tapered piercing needle formed at the bottom of the cartridge connector and having an aperture communicating with the gas passage; and
a cartridge cap formed on the bottom of the cartridge connector around the piercing needle; and
a valve disk slidably mounted in the valve seat and comprising
a bottom cylinder slidably mounted in the valve seat of the valve body and having a longitudinal passage, at least one radial hole and a bottom end, the at least one radial hole defined radially in the bottom cylinder, the longitudinal passage defined axially in the bottom cylinder and communicating with the at least one radial hole, and the bottom end of the bottom cylinder mounted in the valve seat of the valve body to selectively form a restricted gap communicating with the at least one radial hole; and
a top disk connected to the bottom cylinder and having a top and an enlarged valve port defined through the top of the top disk and communicating with the longitudinal passage in the bottom cylinder.

2. The reducing valve as claimed in claim 1, wherein the bottom end of the bottom cylinder has a truncated conical bottom and a flat bottom end to form the restricted gap.

3. The reducing valve as claimed in claim 1, wherein the top disk further has a first annular groove defined radially around the top disk, and an O-ring is mounted in the first annular groove.

4. The reducing valve as claimed in claim 2, wherein the top disk further has a first annular groove defined radially around the top disk, and an O-ring is mounted in the first annular groove.

5. The reducing valve as claimed in claim 4, wherein the bottom cylinder further has a second annular groove defined radially around the bottom cylinder, and an O-ring is mounted in the second annular groove.
